(19) United States
(12) Patent Application Publication
(10) Pub. No.: US 2007/0133398 A1
(43) Pub. Date: Jun. 14, 2007

(54) Method for Implementing Bidirectional Protection Switching in Multiple Protocol Label Switching Network

(75) Inventor: Suping Zhai, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Huawei Technologies Co., Ltd., Shenzhen (CN)

(21) Appl. No.: 11/612,342

(22) Filed: Dec. 18, 2006

Related U.S. Application Data
(63) Continuation of application No. PCT/CN06/00649, filed on Apr. 11, 2006.

(30) Foreign Application Priority Data
Apr. 15, 2005 (CN) 200510064585.4

(51) Int. Cl. H04J 3/14

(52) U.S. Cl. 370/228

(57) ABSTRACT

A method for implementing a bidirectional protection switching in a Multiple Protocol Label Switching (MPLS) network, mainly includes: configuring bidirectional protection switching strategy for two bidirectional Label Switching Path (LSP) each of which includes two LSPs in opposite directions according to an Automatic Protection Switching (APS) protocol; and implementing the bidirectional protection switching according to the bidirectional protection switching strategy pre-con-figured when the bidirectional protection switching is decided to be needed according to the APS protocol in the MPLS network. This invention effectively protects a bidirectional MPLS LSP and ensures equal delay of data traffic in the two directions. Besides, the APS protocol introduced in this invention can also include a unidirectional MPLS LSP protection and thus provides an uniform mechanism for both unidirectional and bidirectional protection in the MPLS network.

This application is a continuation of International Patent Application No. PCT/CN2006/000649, filed Apr. 11, 2006, which claims priority to Chinese Patent. Application No. 200510064585.4, filed Apr. 15, 2005, all of which are hereby incorporated by reference.

### FIELD OF THE TECHNOLOGY

The present invention relates to network communication technology, and more particularly, to a method for implementing bidirectional protection switching in a Multiple Protocol Label Switching Network.

### BACKGROUND OF THE INVENTION

With the development of the network technology, Ethernet services grow step by step from Local Area Networks (LAN) to Metropolitan Area Networks (MAN) and telecommunication networks. For the continuously growing next generation Ethernet services, Multiple Protocol Label Switching (MPLS), based on its unique advantages, has emerged as a first choice among the network technologies. The advantages of the MPLS include: rapid recovery, network scalability, Quality of Service (QoS) ability, service congregation ability and inter-operation of services, etc.

As the MPLS technology has become the key technology of the IP network multi-service bearer, defect detection and protection switching in the MPLS come to be an important concern in the industry so as to ensure that an Operation, Administration and Maintenance (OAM) mechanism of the MPLS can guarantee the high quality and smooth operations of the services and largely reduce the network operation and maintenance costs.

Two basic unidirectional MPLS protection mechanisms are provided in the related arts, that is, 1+1 protection switching structure and 1:1 protection switching structure. The 1+1 protection switching refers to: working traffic is reproduced in a working Label Switching Path (LSP) and a protection LSP simultaneously, then the working traffic in one of the two LSPs is received at a Label Switching Router (LSR) at a merging end of the two paths. The 1:1 protection switching includes: working traffic is only transported by either the working LSP or the protection LSP. Usually a domain equipped with a protection switching structure is called a protection domain, which includes two ends. The end which receives a switching request from the other end and implements switching is called a source end in the protection domain; the other end is the destination end which initiates the switching request in the protection domain.

FIG. 1 is a schematic diagram illustrating a unidirectional 1+1 protection switching structure. As shown in FIG. 1, the receiving end, which receives the working traffic from the working LSP in the unidirectional 1+1 protection switching structure in normal situations is a path merge LSR. When the path merge LSR detects that the working LSP has defects, the protection mechanism is initiated to switch a selector at the path merge LSR so as to achieve the unidirectional protection, i.e., to implement the switch operation from the working LSP to the protection LSP, so as to make the working traffic received from the protection LSP which is in normal state.

FIG. 2 is a schematic diagram illustrating a unidirectional 1:1 protection switching structure. As shown in FIG. 2, the receiving end which receives the working traffic from the working LSP in the unidirectional 1:1 protection switching structure in normal situations is a path merge LSR. When the path merge LSR detects that the working LSP has defects, the path merge LSR initiates the protection mechanism, and sends a Backward Defect Indication (BDI) along the way to the path switch LSR. Upon receiving the BDI, no matter whether the local protection LSP is functioning or not, the path switch LSR implements an LSP switching by the selector and thus achieves a unidirectional path protection, i.e. switches the working traffic from the working LSP to the protection LSP.

### SUMMARY OF THE INVENTION

The invention provides a method for implementing a bidirectional protection switching in a Multiple Protocol Label Switching (MPLS) network, including:

configuring bidirectional protection switching strategy for at least two bidirectional Label Switching Paths (LSPs) in an MPLS network, each of which includes two LSPs in opposite directions,

determining a bidirectional working LSP and a bidirectional protection LSP in the bidirectional LSPs;

switching from the bidirectional working LSP to the bidirectional protection LSP for working traffic according to the configured bidirectional protection switching strategy when the bidirectional protection switching is decided to implement.

It can be seen from the above technical solution provided in this invention, that the method provided by this invention effectively protects the bidirectional data channels of the MPLS LSPs, prevents unequal time delays of the working traffic in the two directions in the unidirectional switching operations and therefore ensures equal delays of the working traffic in the two directions. Besides, this invention introduces an Automatic Protect Switch (APS) protocol including the unidirectional data channel protection in the MPLS LSP and thus provides an uniform mechanism for both the unidirectional and the bidirectional protection. Moreover, in the implementation of this invention, after the bidirectional protection switching, the LSP having defects is idle and can be repaired separately without affecting normal working traffic.

### BRIEF DESCRIPTION OF THE DRAWINGS

FIG. 1 is a schematic diagram illustrating an existing unidirectional 1+1 protection switching structure;

FIG. 2 is a schematic diagram illustrating an existing unidirectional 1:1 protection switching structure;

FIG. 3 is a schematic diagram illustrating a bidirectional 1+1 protection switching structure in accordance with an embodiment of the present invention;

FIG. 4 is a schematic diagram illustrating the bidirectional 1+1 protection switching structure in case that LSP1 in FIG. 3 has defects;

FIG. 5 is a schematic diagram illustrating the bidirectional 1+1 protection switching structure in case that LSP2 in FIG. 3 has defects;

FIG. 6 is a schematic diagram illustrating the bidirectional 1+1 protection switching structure in case that both LSP1 and LSP2 in FIG. 3 have defects;

FIG. 7 is a schematic diagram illustrating a bidirectional 1:1 protection switching structure in accordance with another embodiment of the present invention;

FIG. 8 is a schematic diagram illustrating the bidirectional 1:1 protection switching structure in case that LSP2 in FIG. 7 has defects.

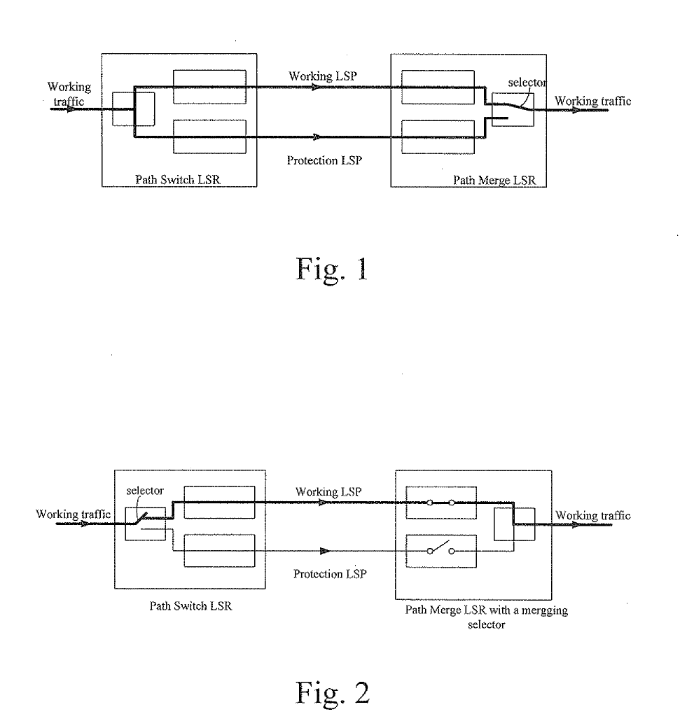

### DETAILED DESCRIPTION OF THE INVENTION

The method provided for implementing the bidirectional protection switching in a MPLS network according to an embodiment of the present invention includes:

Firstly, in the MPLS network, configuring a bidirectional protection switching strategy for a bidirectional LSP based on an Automatic Protection Switching (APS) protocol. The detailed configuring process includes: in the MPLS network determining a protection domain according to the demands; in the protection domain determining two or more bidirectional LSPs, each of which includes two LSPs in opposite directions; defining one of the bidirectional LSPs as the working LSP and the rest as the protection LSP(s); configuring the corresponding protection switching strategy at the source ends or destination ends corresponding to the LSPs with the same direction in the bidirectional LSPs, respectively. The protection switching strategy includes: information of the protection LSP(s) corresponding to the working LSP and necessary switching conditions for the protection switching, e.g., when a protection switching request is received, protection switching operation should be determined. It should be noted that one working LSP may correspond to one or multiple pieces of protection LSPs.

Secondly, the bidirectional protection switching is implemented according to the pre-configured bidirectional protection switching strategy when the MPLS network node determines that the protection switching is necessary to be implemented on the basis of the information born in the APS protocol field of the OAM message received. The APS protocol field of the OAM message bears the protection switching information defined according to the APS protocol.

A preferred embodiment of this invention is hereinafter described in detail with reference to the accompanying drawings to further clarify the aim, technical act and advantages of this invention.

The embodiment of the present invention is implemented on the basis of the APS protocol; therefore the format of an OAM message with the APS protocol field is described hereinafter to provide a clearer understanding of this invention. The format of an OAM message with the APS protocol field is shown in Table 1:

TABLE 1

| | | TTSI | | | |
|---|---|---|---|---|---|
| | | (optional, if | | | |
| Function | | not used to | APS | Padding | |
| Type | Reserved | configure to | protocol | (all | |
| (09Hex) | (00Hex) | all 00Hex) | Octets | 00Hex) | BIP16 |
| 1 octet | 3 octet | 20 octets | 3 octets | 15 octets | 2 octets |

In Table 1, the Function Type field is used to identify the type of the OAM message. In this embodiment, the value of the Function Type field is 0×9 in hex for indicating that the OAM message is an MPLS APS protocol message. The values of the Function Type field may be any other value, as long as it is agreed beforehand.

The Reserved field is used for 32 bit alignment and extension. The Trial Termination Source Identifier (TTSI) field identifies a source end corresponding to the path. The Padding field is used to meet the minimum length requirement of some media; and the BIP 16 field is used for verification.

The APS protocol field in Table 1 is a new field added according to the embodiment of the present invention, which includes a value in octets used for denoting the protection switching information determined according to the APS protocol. The format of the APS protocol field is shown in Table 2:

TABLE 2

| 1 | | | | | | | | 2 | | | | | | | | 3 | | | | | | | |
|---|---|---|---|---|---|---|---|---|---|---|---|---|---|---|---|---|---|---|---|---|---|---|---|
| 1 | 2 | 3 | 4 | 5 | 6 | 7 | 8 | 1 | 2 | 3 | 4 | 5 | 6 | 7 | 8 | 1 | 2 | 3 | 4 | 5 | 6 | 7 | 8 |

| Request/state | Protection | | | | Requested Signal | Bridged Signal |
|---|---|---|---|---|---|---|
| | type | | | | | |
| | A | B | D | R | | |

As shown in Table 2, the APS protocol field includes a request/state field, a protection type field, a requested signal field and a bridged signal field. Table 3 lists the definitions and values of the fields within the APS protocol field in Table 2 which are configured according to the demands of the protection switching:

TABLE 3

| Field | | Value | Description |
|---|---|---|---|
| Request/State | | 1111 | LO, Lockout of Protection |
| | | 1110 | FS, Forced Switch |
| | | 1100 | SF, Signal Fail |
| | | 1010 | SD, Signal Degrade |
| | | 1000 | MS, Manual Switch |
| | | 0110 | WTR, Wait to Restore |
| | | 0100 | EXER, Exercise |
| | | 0010 | RR, Reverse Request |
| | | 0001 | DNR, Do Not Revert |
| | | 0000 | NR, No Request |
| | | Others | Reserved for future international |
| | | | standardization |
| Protection | A | 0 | No APS Channel |
| Type | | 1 | APS Channel |
| | B | 0 | 1 + 1 Permanent Bridge |
| | | 1 | 1:n no Permanent Bridge |
| | D | 0 | Unidirectional switching |
| | | 1 | Bidirectional switching |
| | R | 0 | Non-Invertive operation |
| | | 1 | Invertive operation |

| | | |
|---|---|---|
| Requested Signal | 0 | Null Signal |
| | 1-254 | Normal Traffic Signal 1-254 |
| | 255 | Extra Traffic Signal |
| Bridged Signal | 0 | Null Signal |
| | 1-254 | Normal Traffic Signal 1-254 |
| | 255 | Extra Traffic Signal |

The detailed description of this invention is given hereinafter based on the above-described format and contents of the OAM message with the APS protocol field.

This invention includes two application structures for the bidirectional protection switching, that is, 1+1 bidirectional protection switching and 1:1 bidirectional protection switching.

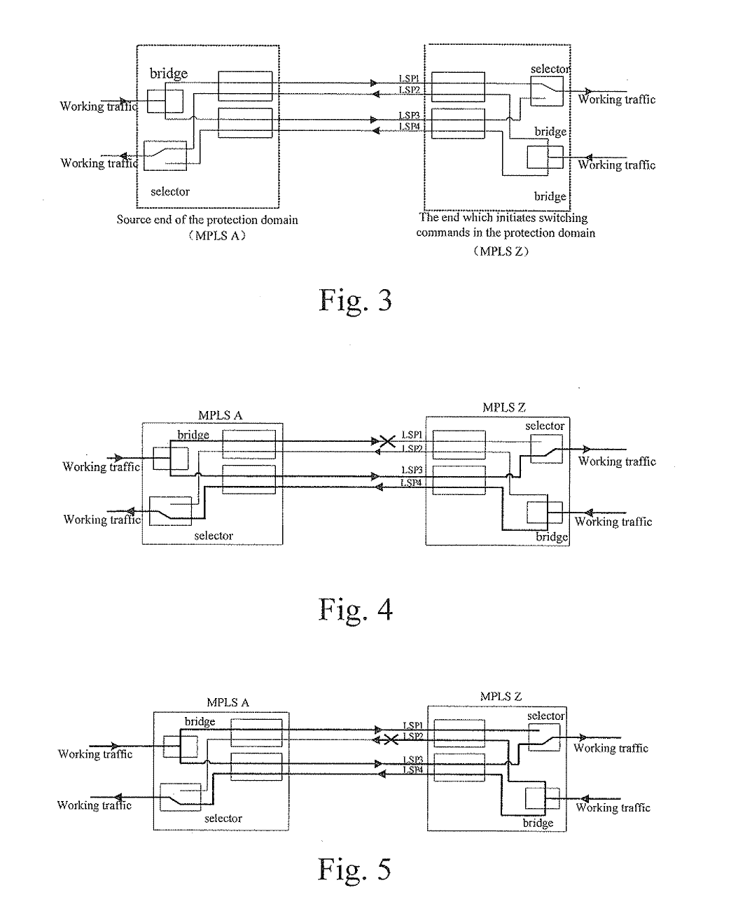

FIG. 3 is a schematic diagram illustrating the bidirectional 1+1 protection switching structure in accordance with an embodiment of this invention. As shown in FIG. 3, in the bidirectional 1+1 protection switching structure, the selector at the destination end in the protection domain decides whether to implement the protection switching based on the comparison between the information on protection switching in the APS protocol message sent from the peer end thereof and the information on protection switching configured in the local LSR, e.g. whether to implement the unidirectional switching, invertible switching, etc.

In normal situation, working traffic is transported by the working LSP and the protection LSP bidirectionally at the same time in the 1+1 protection switching pattern. From the LSPs connected with the selectors as shown in FIG. 3, it can be seen that LSP1 and LSP2 are the working LSPs, LSP3 and LSP4 are the protection LSPs. When the OAM message defined in the current protocol, such as Connectivity Verification (CV) or Fast Failure Detection (FFD) message, is used for verifying whether the LSPs are available or not, the message will be sent at the source ends respectively corresponding to the working LSP and the protection LSP, transported to the corresponding destination ends by the two LSPs.

An example is given below to illustrate the detailed operations of the protection switching in the 1+1 bidirectional protection switching mechanism when defect occurs.

FIG. 4 is a schematic diagram illustrating the bidirectional 1+1 protection switching structure when LSP1 in FIG. 3 fails. As shown in FIG. 4, provided that MPLS A is the source end corresponding to LSP1 and. LSP3 in the protection domain, MPLS Z is the corresponding destination end which initiates the switching request in the protection domain, working traffic is transported by LSP1 and LSP2 in normal cases. If LSP1 fails in the direction from MPLS A to MPLS Z, as MPLS Z cannot receive the CV or FFD message, it detects a defect of Loss Of Connection (dLOC), or a defect of Trail Termination Source Identifier (dTTSI) mismatch, or dTTSI mismerge, or a defect of Express (dExpress), etc. Then MPLS Z, based on the APS protocol, requests to implement a 2-phase protection switching which means information interaction will occur twice. The detailed process of the bidirectional protection switching is:

MPLS Z informs MPLS A of relative protection switching information through sending an APS protocol message with a protection switching request; MPLS A switches the selector to LSP4 and returns a switching completion message as an APS response to MPLS Z upon determining to implement the protection switching based on the comparison between the protection switching information saved in MPLS A itself and the protection switching information born in the request/state field of the APS protocol field in the protection switching request received from MPLS Z. It should be noted that if the priority level of the protection switching information received is lower than that of the protection switching information saved in MPLS A itself, e.g., when the protection switching information saved in MPLS A includes the lockout of protection value, it shall be determined that no protection switching is needed.

And then MPLS Z switches the selector at the local end to LSP3 based on the switching completion message received from MPLS A. Now the working traffic is switched from LSP1 and LSP2 to LSP3 and LSP4.

FIG. 5 is a schematic diagram illustrating the bidirectional 1+1 protection switching structure in case LSP2 in FIG. 3 fails. As shown in FIG. 5, provided that working traffic is transported by LSP1 and LSP2 in normal cases, and when LSP2 fails in the direction from MPLS Z to MPLS A, as MPLS A cannot receive the CV or FFD message, MPLS A will detect dLOC, or dTTSI mismatch, or dTTSI mismerge, or dexpress, etc. Then MPLS A requests to implement the protection switching in the way of 2-phase protection switching based on the APS protocol. The detailed operation of the bidirectional protection switching includes:

MPLS A informs MPLS Z of relative protection switching information through sending an APS protocol message with a protection switching request; MPLS Z switches the selector to LPS3 and returns a switching completion message as an APS response to MPLS A upon determining to implement the protection switching based on the comparison between the protection switching information saved in MPLS Z itself and the protection switching information born in the request/state field of the APS protocol field in the protection switching request received from MPLS A. It should be noted that if the priority level of the protection switching information received is lower than that of the protection switching information saved in MPLS Z itself, e.g., when the protection switching information saved in MPLS Z includes the lockout of protection value, it shall be determined that no protection switching is needed.

And then MPLS A switches the selector at the local end to LSP4 based on the switching completion message received from MPLS Z and completes the whole bidirectional protection switching flow.

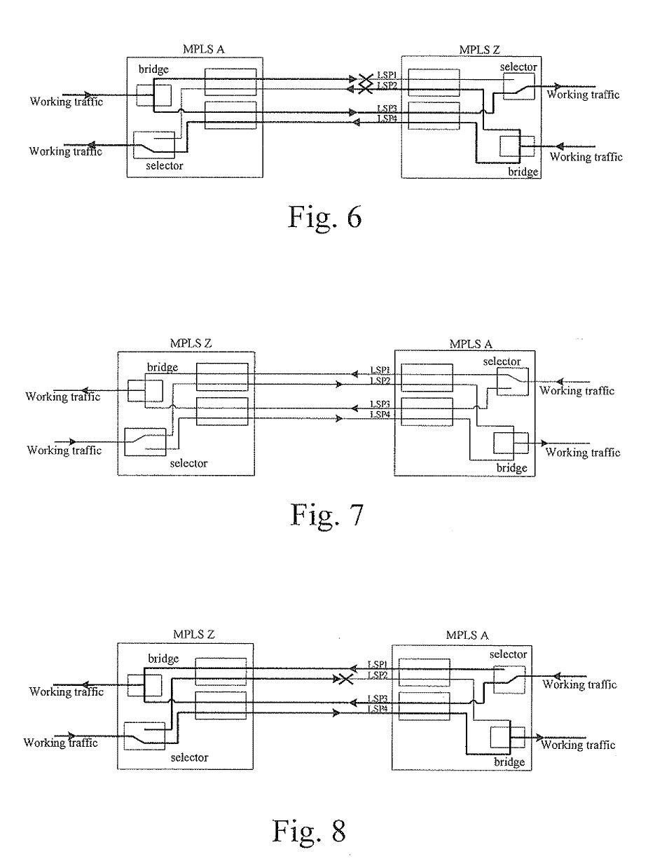

FIG. 6 is a schematic diagram illustrating the bidirectional 1+1 protection switching structure in case LSP1 and LSP2 in FIG. 3 fail. As shown in FIG. 6, provided that in normal cases working traffic is transported by LSP1 and LSP2, when both LSP1 and LSP2, which constitute a bidirectional LSP, fail at the same time, there are 3 possible situations given as below.

In the first possible situation:

MPLS A and MPLS Z detect the defects in LSP1 and LSP2 at the same time, and send an APS protocol message with a protection switching request to their peer ends, respectively;

according to the protection switching request, MPLS A and MPLS Z check whether the protection switching information, e.g., the lockout of protection value, is still valid before deciding whether to implement the protection switching. If the lockout of protection value is invalid, the protection switching shall be implemented at both ends simultaneously through switching the corresponding selectors and an APS response shall be sent to their peer ends at the same time informing the peer end that the switch has already been completed;

the peer ends receives the APS response without any further operation since the local protection switching information is consistent with the protection information born by the APS protocol field in the local end and the switching operation at the selectors has been completed.

In the second possible situation:

MPLS A detects the defects in LSP2 first and initiates an APS protocol message with a protection switching request. The corresponding operations are the same as the implementation example shown in FIG. 5.

In the third possible situation:

MPLS Z detects the defects in LSP1 first and initiates an APS protocol message with a protection switching request. The corresponding operations are the same as the implementation example shown in FIG. 4.

FIG. 7 is a schematic diagram illustrating the bidirectional 1:1 protection switching structure in accordance wit another embodiment of this invention. The detailed descriptions of such structure are given below.

In the bidirectional 1:1 protection structure as shown in FIG. 7, MPLS A, as a source end in the protection domain, chooses the working LSP or the protection LSP for transmitting the working traffic through switching the selectors. From the LSPs connected with the selectors shown in FIG. 7, it can be seen that LSP1 and LSP2 are the working LSPs, LSP3 and LSP4 are the protection LSPs. LSP1 and LSP3 always merge at MPLS Z, as the destination end thereof. If the CV or FFD message is used to verify the availability of the link of the LSP, the CV or FED message will be sent at the source end in the protection domain, and transported to the corresponding destination end; both the working LSP and the protection LSP send the CV or FFD message.

The operation of the bidirectional 1:1 protection switching mechanism provided in accordance with this embodiment of the present invention in case the defect occurs are described below:

FIG. 8 is a schematic diagram illustrating the bidirectional 1:1 protection switching structure in case LSP2 in FIG. 7 fails. As shown in FIG. 8, provided that working traffic is transported by LSP1 and LSP2 in normal cases, and when LSP2 fails in the direction from MPLS Z to MPLS A, as the MPLS A cannot receive the CV or FED message, MPLS A shall detect the defects in LSP2 and request to implement the 2-phase protection switching based on the APS protocol. The detailed operations of the bidirectional protection switching include:

MPLS A informs MPLS Z of relative protection switching information through an APS protocol message with a protection switching request. MPLS Z switches the selector to LPS4 and returns a switching completion message as all APS response to MPLS A upon determining that the protection switching is needed based on the comparison between the protection switching information saved in MPLS Z itself and the protection switching information born in the request/state field of the APS protocol field in the protection switching request received from MPLS A. It should be noted that if the priority level of the protection switching information received is lower than that of the protection switching information saved in MPLS A itself, e.g., when the protection switching information saved in MPLS A includes the lockout of protection value, it shall be determined that no protection switching is needed.

And then MPLS A switches the selector at the local end to LSP3 based on the information received from MPLS Z and completes the whole bidirectional switching flow.

The unidirectional protection switching can also be achieved with the method provided in accordance with an embodiment of this invention.

In the unidirectional 1:1 protection switching, defects are detected at the Path Merge LSR and a message shall be sent to the Path Switch LSR to implement the protection switching. Interaction of the state information from both ends based on the APS protocol allows the Path Merge LSR and the Path Switch LSR to recognize the defect request priority through the comparison between the priority level of the local switching information and that of the information sent from the peer end. The Path Switch LSR finally decides whether to implement the protection switching. If the priority level of the information from the peer end is lower than that in the local end, the protection switching shall not be implemented.

The foregoing is the only preferred embodiments of this invention and is not used for limiting this invention, any modification, equivalent replacement or improvement made under the spirit and principles of this invention is included in and shall be protected by the protection scope of this invention as set by the appended claims.

What claimed is:

1. A method for implementing a bidirectional protection switching in a Multiple Protocol Label Switching (MPLS) network, comprising:
configuring bidirectional protection switching strategy for at least two bidirectional Label Switching Paths (LSPs) in an MPLS network, each of which includes two LSPs in opposite directions,
determining a bidirectional working LSP and a bidirectional protection LSP in the bidirectional LSPs;
switching from the bidirectional working LSP to the bidirectional protection LSP for working traffic according to the configured bidirectional protection switching strategy when the bidirectional protection switching is decided to implement.

2. The method according to claim 1, wherein the bidirectional protection switching strategy is configured for the bidirectional LSPs on the basis of an Automatic Protection Switching (APS) protocol.

3. The method according to claim 1, wherein the step of configuring the bidirectional protection switching strategy for the bidirectional LSPs comprises:
configuring the corresponding protection switching strategy at source ends or destination ends corresponding to the LSPs which are of the same direction among all the bidirectional LSPs, respectively.

4. The method according to claim 3, wherein the step that the bidirectional protection switching is decided to implement comprise:
when an Operation, Administration and Maintenance (OAM) message received by the ends in the protection domain indicates that the protection switching is needed, the ends deciding that the protection switching is needed.

5. The method according to claim 4, wherein, the OAM message comprises:
an APS protocol field, for bearing protection switching information based on the APS protocol.

6. The method according to claim 5, wherein, the step of switching from the bidirectional working LSP to the bidirectional protection LSP comprises:
each of the ends in the protection domain sending a protection switching request to the corresponding peer end when deciding to implement the bidirectional protecting switching;
upon receiving the protection switching request, the peer end switching from the bidirectional working LSP to the bidirectional protection LSP according to the bidirectional protection switching strategy, and sending a response to the end which sends the protection switching request;
upon receiving the response, the end implementing corresponding protection switching operation locally, switching from the bidirectional working LSP to the bidirectional protection LSP.

7. The method according to claim 5, wherein, the step of switching from the bidirectional working LSP to the bidirectional protection LSP is implemented based on the comparison between the protection switching information in the APS protocol field of the OAM message received from the peer end and the bidirectional protection switching strategy saved in the local end.

8. The method according to claim 5, before switching from the bidirectional working LSP to the bidirectional protection LSP, further comprising.
The bidirectional working LSP and bidirectional protection LSP are determined based on the information saved in a local Label Switching Router (LSR) at the start-up of the source end or destination end, and transmitting the working traffic through the working LSP and the protection LSP at the same time, or through the working LSP only.

9. The method according to claim 5, wherein, the OAM message is a Connectivity Verification (CV) message or a Fast Failure Detection (FFD) message;
the step that the bidirectional protection switching is decided to implement comprises:
inserting the CV or FFD message at the source ends corresponding to the working LSP and the protection LSP in the MPLS network,
the destination ends corresponding to the working LSP and the protection LSP deciding whether the protection switching is needed according to the CV/FFD message.

10. The method according to claim 5, wherein, the APS protocol field comprises: a request/state field, a protection type field, a requested signal field and a bridged signal field.

11. The method according to claim 10, before deciding that the protection switching is needed, further comprising:
the end which receives the OAM message comparing priority level of the protection switching information pre-configured therein with the priority level of the protection switching information born in the request/state field of the APS protocol field in the OAM message received; if the priority level of the protection switching information received is lower than that pre-configured in the end, no protection switching being implemented; otherwise implementing the protection switching.

12. The method according to claim 1, wherein the protection switching strategy comprises: information of the protection LSP corresponding to the working LSP and necessary switching conditions for the protection switching.
